(19) United States
(12) Patent Application Publication
(10) Pub. No.: US 2008/0125317 A1
(43) Pub. Date: May 29, 2008

(54) Heating Additive for Three Dimensional Optical Memory

(75) Inventors: Ortal Alpert, Jerusalem (IL); Yair Salomon, Jerusalem (IL); Andrew N. Shipway, Jerusalem (IL)

Correspondence Address: BROWDY AND NEIMARK, P.L.L.C.;624 NINTH STREET, NW, SUITE 300, WASHINGTON, DC, 20001-5303, US

(73) Assignee: MemPile, Inc. c/o PHS Corporate Service, Inc., Suite, Wilmington, DE (US)

(21) Appl. No.: 11/813,845

(22) PCT Filed: Jan. 12, 2006
(86) PCT No.: PCT/IL06/00050

§ 371 Date: Jul. 12, 2007

Related U.S. Application Data
(60) Provisional application No. 60/643,112, filed on Jan. 12, 2005.

(51) Int. Cl. B41M 5/24

(52) U.S. Cl. 503/201; 503/200; 503/218

(57) ABSTRACT

A method for data inscription in an acrylic polymer-based photochromic medium is provided in which the photochromic groups are bound to the polymeric matrix. The data is inscribed by irradiating small volume portion with an electromagnetic irradiation that causes a change in state of the photochromic groups from a first to a second state. Said volume portion is heated so as to cause an increase in temperature of said portion at the time of data inscription. The heating may be external or internal. Internal heating makes use of additives that dissipate heat, following their irradiation, to their immediate vicinity. Provided is also a novel acrylic polymer-based photochromic medium comprising said additives.

### FIELD OF THE INVENTION

This invention relates to a new medium useful for a 3-Dimensional optical memory.

### BACKGROUND OF THE INVENTION

Photochromic media are of rapidly increasing interest since they offer the possibility of massive data storage. Photochromic media consists of chromophores which whereby upon a photochemical excitation of the chromophores, a change of the chromophore's state (e.g. isomerization) occurs (WO 01/73,769; U.S. Pat. No. 5,268,862). Such a change of the chromophore's state is the inscription (“writing”) of data. In 3-dimensional optical storage, the photochromic media is generally an organic material, which contains chromophores (the molecular data storage component) embedded or bound in a matrix, preferably a polymer (WO 03/70,689). The matrix provides the required mechanical properties to the photochromic media and the excitation of the chromophores at a certain point amounts to the inscription of data at that certain point. The change as a result of excitation may be slow or low-yielding because of an energy barrier to the change in the excited state. This may require high laser powers for the writing of data at fast rates. An approach to increase data rates and/or reduce laser power is highly desirable.

In addition to the problem of writing speed, many photochromic media suffer from problems of destructive reading. This effect is essentially a small amount of “writing” that occurs every time a data point is read. Consequently, after a limited number of read cycles the data is effectively erased.

The signals obtained from such photochromic media disks are also very small, and require complex and expensive detection systems. Often, the requirements for the “read” and “write” photochemical processes are in some way competitive, so a trade-off has to be reached between them, where neither is optimized.

Photochromic data storage technology stores data by virtue of the different properties of the states of switchable molecules. This switching (for example, between cis and trans configurations, spiropyran and merocyanine forms, the “open” and “closed” forms of diarylethenes and fulgides, or the two forms of phenoxynaphthacene quinones) requires molecular movement, and as such is strongly influenced by the properties of the matrix in which the molecules are encapsulated.

Molecular switching is optimized in matrices that offer low molecular friction and that tend to stabilize the transition state of switching. Unfortunately, the requirement of low molecular friction favors low density, high mobility matrices, which tend to be weak and/or soft. These properties of preferred matrices are problematic for the production of usable media, since they do not possess the required mechanical properties for strength and dimensional stability. Therefore, a compromise is often made, leading to photochromic media that has the potential to be much more sensitive.

### SUMMARY OF THE INVENTION

The present invention provides an improved polymer-based photochromic medium in which the photochromic groups are bound to the polymeric matrix. The improvement resides in the enhancement of the data inscription process (“writing”). Such an improvement is achieved in accordance with the invention by heating the medium during the “writing” process. Such heating facilitates the phase change and/or structural changes of the photochromic group. Heating may be achieved either through external or internal heating. External heating is achieved by exposing the polymer during writing to an external heat source. Internal heating is achieved by incorporating into the polymer at least one group of heating additives whereby upon irradiation of the polymer by an appropriate irradiation, the heating additives dissipate heat in a non irradiative manner to their near vicinity.

Thus, the present invention provides a method for data inscription in a polymer-based photochromic medium in which the photochromic groups are bound to the polymeric matrix, the data being inscribed by irradiating small volume portion, typically in a size ranging from the direction limit (micron or submicron) to about 10 times larger, with an electromagnetic irradiation that causes a change in state of the photochromic groups from a first to a second state, the method comprises heating at least said volume portion to cause an increase in temperature of said portion at the time of data inscription.

The polymer backbone is a transparent polymer enabling the passage of light with essentially no interference. Typical examples of polymers are acrylic-based such as poly(methylmethacrylate) (PMAA) or poly(isobornylmethacrylate) polystyrene (PS), polymaleimides, and copolymers thereof. The chromophore may be present in the form of pendant groups, as part of the polymeric backbone or may be doped in the polymer. It may be introduced into the polymer in the form of a co-monomer such that the polymer is a co-polymer comprising a polymerizable active chromophore monomer co-polymerized with a monomer.

According to one embodiment of the invention such heating is achieved by a heating device that heats at least a portion of the medium prior to data inscription. Such a heating device may be any heating device that heats the medium through conduction or irraditaion, e.g. a hot plate, a device that dissipates infrared (IR) irradiation, etc.

According to another embodiment the heating is achieved through the use of additives in the medium that absorb electromagnetic irradiation, e.g. visible light or IR irradiation and dissipate heat, preferably in a non-irradiative manner, to their immediate surroundings. According to this embodiment, the invention provides an acrylic polymer matrix with at least one type of chromophore bound to the polymeric matrix or embedded therein, and comprising and at least one group of heating additives homogenously distributed therein.

The heating additive is a dye which preferably is a non fluorescence dye which upon its irradiation dissipates heat to its vicinity. The dye is of a kind that does not interfere with the absorbance or fluorescence of the chromophoric moiety and preferably the dye should have an absorption maximum in the region of about 0.9 to 1.0 micron. The concentration of the heating additive depends on the absorption intensiy of the particular dye, the thickness of the media, the strength of the irraditation, and the desired temperature rise. The concentration is preferentially in the range of 80-1400 ppm. Many examples of suitable dyes are commercial available. These include ADS1065 (from Americam Dye Source), SDA4137, SDA7816, SDA7779 (HW Sands), and Epolin 2057.

According to one preferred embodiment, the chromophoric group is a stilbene derivative of the following formula (I):

Ar¹C(R¹)═C(R²)Ar² (I)

wherein Ar¹ and Ar² are phenyl groups optionally independently substituted with one or more groups selected from —C₁₋₆alkyls, —OC₁₋₆alkyl, —SC₁₋₆alkyl and, —C₁₋₆OH, thiols and their salts, NR′R″, R′ and R″ being independently hydrogen or C₁₋₆alkyl; R¹ and R² are substituents selected from nitriles selected from —(CH₂)ₙCN, n being 0, 1 or 2, halides, RCOOH, R being C₁₋₆alkyl, their C₁₋₆exters, or a nitro compound selected from —(CH₂)ₙNO₂, n being 0, 1 or 2.

C₁₋₆alkyls may be straight or branched alkyls, preferably a methyl, ethyl, propyl, isopropyl, butyl, sec-butyl or tert-butyl or pentyl groups; the nitrile is preferably a —CN group and the nitro compound is preferably an —NO₂ group

A polymerizable active chromophore monomer useful in accordance with the invention is preferably a compound of the following formula (II):

Ar¹C(R¹)═C(R²)Ar²-M (II)

wherein Ar¹, Ar², R¹ and R² are as defined above and M is a polymerizable monomeric moiety. Specific examples of M are acrylate, methacrylate, styryl, and maleimide.

Exemplary photochromic-modified monomers are those of the following formula (IV):

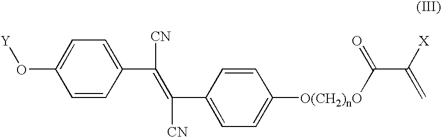

wherein X and Y are as defined above.

Particular examples are polymerizable active chromophore monomers of the following formula (IV) and (V) (also referred to herein as “eMMA” and “eAA”, respectively):

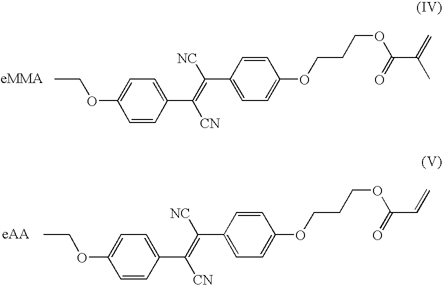

The active chromophoric groups as well as said heating additives are typically bound to monomeric groups and thereby become bound to the polymeric matrix during the polymerization In such a polymer, the linked chromophore (the chromophores bound to the monomers) typically comprises between 5 to 50 wt % of and the heat additive is present at 80-1400 ppm.

The invention further provides a photochromic medium comprising the above-mentioned polymer matrix.

The invention yet further provides a 3-dimensional (3-D) optical memory comprising said photochromic medium. The invention further provides a 3-D optical memory unit comprising said 3-D optical memory and means for irradiating the chromophore (“writing”) and means for irradiating the heating additive. The memory unit comprises a reading system, a tracking and retrieving system. Such system is disclosed in U.S. application Ser. No. 11/285,210; and U.S. application Ser. No. 11/290,818 and may be adapted to include the additional elements for heating as disclosed below. The read and write systems comprise appropriate light sources, typically laser diodes of appropriate wavelengths and an optical system capable of co-focusing ‘write’ beam of first wavelength and ‘heating’ beam of second wavelength to locations which relative displacement is controlled and is typically zero, optical system such as described in U.S. application Ser. No. 11/290,818 or using microscope lens systems that are corrected for both chromatic and spherical aberrations [e.g. Olympus LCPlanFI lens]. The extent of the focusing of the light can be controlled by pre-shaping of the beam and in particular the focus of the heating beam can be pre-shaped to surround the focus of write beam, so as to control the size of the heating locality which may be diffraction limited. As the writing is typically performed in media that is moving relative to the focused beams, the special inclusion of the write focus point within the heating focus provides heating that precedes and succeeds the ‘writing’ event both in space and time. In addition to control of the shape and center point of the focus of the beam by the optical system, the intrinsic properties of the light source may be used. Thus a multi-mode diode may be used to provide a focused stripe instead of a focus point, said focus stripe allowing localized heating along a track on which data is to be recorded. Typically, for a multimode diode, the size of such stripe or irradiated locality is similar to the size of the aperture, ranging from 100 to 200 micron. Using said optical system any volume in the bulk of the 3D memory can be access to record or retrieve data in the form of optically differentiable marks and spaces. Said marks and spaces typically arranged in the form of spiral track in virtual layers.

The invention is further directed to a method for facilitating the writing process in a three dimensional optical memory by lowering the intensity of the pulse required for writing, i.e. for inscribing data, increasing the rate in which data is written at a given intensity, or by decreasing the number or duration of pulses needed for data inscription. Such a lowering in the intensity is achieved by incorporating into the memory a heating additive. The heating additive may be a dye which is irradiated concurrently with or slightly preceding the writing thus generating heat. Preferably the dye is a non fluorescent dye, where the irradiation of the non fluorescent dye generates heat which in turn causes local changes to the environment where data is inscribed, hence requiring less energy for inscribing the data with a writing pulse. Heating may be done locally only in the volume portion where data is to be inscribed or can be done on larger portions of the three dimensional optical memory at times even by heating the entire 3-D optical memory by irradiation or by other means.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1A and 1B display the ultraviolet-visible-infrared spectra of several discs whose compositions are given in Table 1.

FIG. 2 illustrates the increase of isomerization yield as the viscosity in decreased (the solvent concentration is decreased in a rigid matrix).

FIG. 3 illustrates the increase of isomerization yield at elevated temperatures achieved by adding a non-fluorescent dye according to the present invention.

FIG. 4 (A) illustrates the fluorescence of 4 points in an ePMMA based chromophoric medium emitted during the “writing” process at a temperature of 90° C. (B) illustrates the fluorescence of 4 points in an ePMMA based chromophoric medium emitted during the “writing” process at a temperature of 30° C.

FIG. 5 (A) illustrates the 1D scanning of the 4 spots of FIG. 4(A) (B) illustrates the 1D scanning of the 4 spots of FIG. 4(B).

### DETAILED DESCRIPTION OF SPECIFIC EMBODIMENTS

The invention is thus directed to improved polymers being part of a photochromic medium, preferably in the form of a disc used as 3-dimensional optical memory, where the disc comprises, in addition to the chromophore being the active agent for data storage, also a dye serving as a heating agent for heating at least the volume portion in which data is inscribed (“written”). The volume portion is in the order of the wavelength's dimensions. According to the invention, the incorporation of the dye, which preferably is a non-fluorescence dye, results in an increase in the rate of data “writing” in photochromic media by heating as writing takes place. Heat may enhance the rate of writing by either or both of two mechanisms: (a) An increase in temperature causes an increased rate in any reaction which has a nonzero activating energy (Arrhenius mechanism). (b) The increase in temperature may induce a phase change or other structural change in the matrix, which allows the mechanical movements necessary for photochromic change to take place more easily (molecular friction mechanism). Heating according to the present invention involves the inclusion of an absorbing dye within the media, which converts incident light of particular wavelength ranges into heat. Writing is done in the presence of a light source in the particular wavelengths which is focused at the point where writing is to take place. The wavelength of this auxiliary light, and the absorbance of the absorbing dye, are removed from any excitation or signal wavelength of the read or write processes. The dye is preferably non-fluorescent and should not interfere with the optical quality of the disk. The heating may be performed only in the locality of the momentary writing, or it may be carried out over a large portion (or even the whole) of the media unit. The fact that heat activates writing also means that the problem of destructive reading is minimized, since the heat required for writing need not be switched on during data reading.

A simple method of measuring the quantum yield in a disk was developed. This method involves measuring the time-dependant fluorescence from the disk as it is continually irradiated with UV light. This kind of one-photon result is identical to the two-photon situation, since the long-lived excited state is the same (as verified by noting identical fluorescence spectra and excited-state lifetimes for one-photon and two-photon excitation).

Samples cut from a standard disk were measured, and their quantum yields of isomerization were measured at various temperatures. The disk was prepared in the dark to avoid any interference from ambient light, and a highly attenuated frequency-tripled YAG (355 nm), producing ˜10 ns pulses, was used as a light source. It is an advantage of one-photon measurements that very high temperatures are easily examined, since slight deformations of the media are inconsequential.

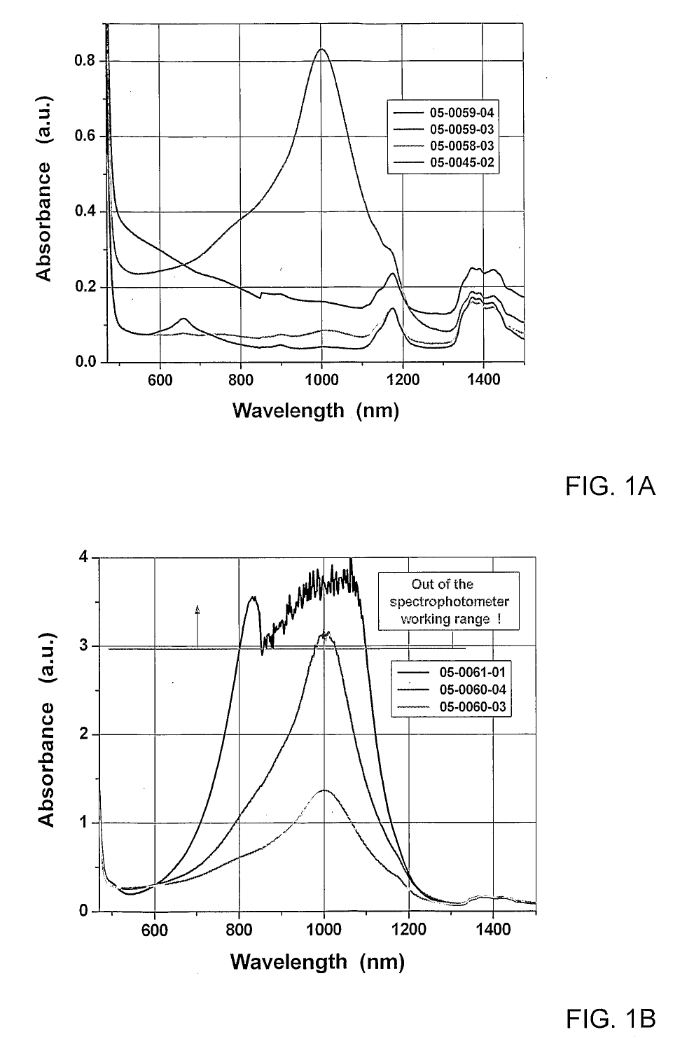

Turning to FIG. 1, there is given the ultraviolet-visible-infrared spectra of several copolymers comprising various concentrations of eMMA (the monomer comprising the chromophore as defined above), MMA and MA (two monomers defined above) together with a non-fluorescent dye EPOLIN 2057®. The addition of the dye may give rise to a more pronounced inscription of data evident by an enhanced ultraviolet-visible-infrared spectrum.

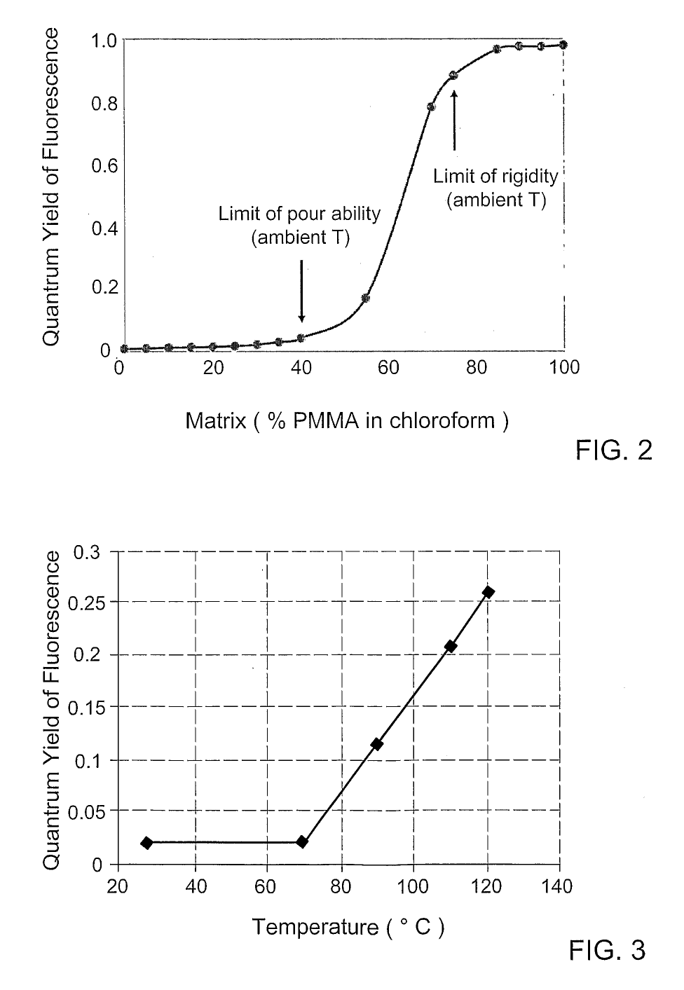

Some chromophoric groups such as diaryethenes derivatives may exist in either a cis or a trans configuration and can be used for 3D memory. These chromophores may be excited by a non-linear mechanism as is evident for eMMA by the fact that it can be excited with 670 nm light and emit fluorescence at about 500 nm. Once the diarylethenes are excited, they relax to the ground state that is either one of the isomeric forms or to a different non isomeric form. In many cases the relaxation to the other non-isomeric forms is insubstantial. The relaxation towards one of the isomeric forms may be either irradiative (fluorescence) or non-irradiative. Spectroscopic monitoring of such relaxation possesses shows the following phenomenon. It is measured that in rigid disks, at ambient temperatures the fluorescence quantum yield is very high and the isomerization quantum yield is very low while in the solution extreme there is essentially no fluorescence and there is a very high isomerization quantum yield (approaching the theoretical maximum of 0.5%). FIG. 2 shows the measured effects of viscosity on the fluorescence quantum yield which is complementary to the combined yield of non-irradiative and on the isomerization yields. FIG. 2 shows the change in fluorescence quantum yield as function of the decrease in the amount of chloroform in the matrix rendering the medium more rigid. Evidently, softening the medium (increasing the concentration of chloroform) results in higher quantum yield of isomerization. FIG. 3 demonstrates the temperature-dependence of the quantum yield of isomerization, as measured from a “standard” 10% concentration disk. As apparent, there is an increase in the “writing” or isomerization yield with the increase of temperature. The heating increases the write-susceptibility and may be attributed to the decrease in matrix rigidity.

The photostability of the heating dye is not important in a write once read many (WORM) medium since each data point only requires heating once. In a rewritable medium however, the stability of the dye should be taken into consideration.

The invention further concerns a method to address the above problems associated with many photochromic media. A blank disk is delivered to the user in a state that is optimized for the “write” process, such that sensitive, high-yielding, and fast data writing can be achieved. The switching between “read optimized” and “write-optimized” states may be a reversible process (resulting in a potentially rewritable medium). In such a case, the switching is externally activated e.g. by specific light source or may be a one-way process (resulting in a WORM medium) in which after or during the writing of data, the disk (or parts thereof) is subjected to a process that in some way changes the structure of the disk from a “write-optimized” state to a “read-optimized” state. This state allows the written data to be read many times with optimized signal strength and little or no destruction of data. An example of such a process is the activation by heat of a cross-linker that changes the state of the matrix from a write-susceptible matrix to a rigid cross-linked matrix optimized for reading.

Preferred dyes according to the present invention are those which do not interfere with the absorbance spectra of the active chromophores and therefore their ideal absorbance maximum depends on the absorbance of the chromophore used. According to the present invention, non-fluorescence dyes having an absorbance maximum in the region of about 0.9 to 1.0 micron are used.

Preferably, the discs according to the present invention are all copolymers of either methylmethacrylate or methacrylate copolymerized with chromophores bearing a MMA or MA moiety. Hence the chromophores are chemically modified methacrylate or acrylates with chromophores linked to the monomer via a linker. Such two cliromophores (modified monomers) are those of formulae (IV) and (V) shown above. Specific modified monomers are those of the following formulae:

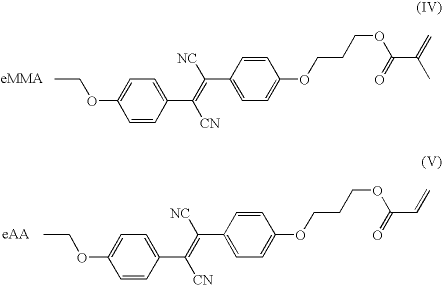

In particular, “eMMA” is employed whose synthesis is given in detail in WO 03/070689. Polymerizing the two chemically different monomers yields the desired copolymer. The desired dye is mixed with a monomer and subsequently polymerized with the chromophore to yield the desired disc. The polymerization may be a radical or ionic polymerization. In case of radical polymerization, care should be taken with the selection of peroxides. AIBN (azobisisobutyronitrile) may be used as the radical source since regular peroxides, such as for benzoyl peroxide may cause discoloration of the dye. In order to further protect the dye, methacrylic acid may be added at about 5% (wt) since the polymerization reaction is pH sensitive and further the presence of acid slows the destruction of the dye.

The following Table 1 lists several copolymers varying in their composition each having different amounts of the various components.

TABLE 1

| Sample # | Formulation |
|---|---|
| 05-0061-01 | 5% Methacrylic acid, 0.8% AIBN, 10% eMMA, 84.2% |
| | 1000 ppm epolin 2057/MMA solution |
| 05-0060-04 | 5% Methacrylic acid, 0.8% AIBN, 10% eMMA, 34.2% |
| | 1000 ppm epolin 2057/MMA solution, 50% MMA |
| 05-0060-03 | 5% Methacrylic acid, 0.8% AIBN, 10% eMMA, 25.2% |
| | 1000 ppm epolin 2057/MMA solution, 59% MMA |
| 05-0059-04 | 5% Methacrylic acid, 0.8% AIBN, 10% eMMA, 8.4% |
| | 1000 ppm epolin 2057/MMA solution, 75.8% MMA |
| 05-0059-03 | 5% Methacrylic acid, 0.8% AIBN, 10% eMMA, 16.8% |
| | 1000 ppm epolin 2057/MMA solution, 67.6% MMA |
| 05-0058-03 | 4.76% Methacrylic acid, 0.95% AIBN, 9.5% eMMA, |
| | 84.8% 100 ppm epolin 2057/MMA solution, |
| 05-0045-02 | 2.5% AIBN, 10% eMMA, 87.5% 100 ppm epolin 2057/ |
| | MMA solution |

The ultraviolet-visible-infrared spectra of these copolymers are given in FIGS. 1A and 1B. The concentration of the incorporated dye is controlled in order to allow repeatable heating of the volume portions to be recorded by a light beam of controlled spectrum focus and power. The light beam and dye concentration are mutually optimized for efficient heating without excessive irradiation. Linear absorption in disk depths in between the irradiation source and the data recording locality may be compensated by increase of either the dye concentration or increase of the irradiation intensity.

### EXAMPLES

### General

A solution containing 1000 ppm of the Epoline 2057 dye (absorbing at 980 nm) is prepared by adding 100 mg of the dye (analytical balance) to 100 g of MMA. The solution was gently heated to about 45C. ° in an ultrasonic bath.

The above-mentioned MMA/Dye solution (1000 ppm dye) was used together with the radical initiator AIBN (azobisisobutyronitrile) and the chromophore eMMA for the casting mixture to obtain a desired photochromic medium (a disc). Methacrylic Acid was also added at 5% wt concentration, as this reaction is pH sensitive, and the Acid slows the destruction of the dye by the radicals.

### Example 1

### Preparation of a Disc Having 110%/wt EMMA

A typical disc comprises:

2 g—eMMA

0.16 g—AIBN

1 g—Methacrylic Acid

16.84 g—MMA (Using the 1000 ppm 980 nm Heating dye/MMA mixture).

Prepolymerization treatment comprises of heating the mixture for about 20-45 minutes at a temperature of 55 to 65° C. In particular, the above mixture was pretreated at 60° C. for 20 minutes, and then filtered using a 1 μm PTFE syringe filter, then degassed for 30 seconds and then used to fill the mold. The filled mold was placed in the oven at 60° C. overnight. Polymerization may also be carried in a water bath.

### Example 2

A photochromic polymer comprising ePMMA as the active chromophoric medium was mounted in a temperature-controlled read/write apparatus, and data spots were written at different temperatures. A difference in modulation between spots written at 90° C. and spots written at 30° C., when both are read at 30° C. were found. Spots written at 90° C. showed about twice the modulation of spots written at 30° C. Additional experiments were conducted to quantify the possible improvement factor in different polymer matrices at different temperatures.

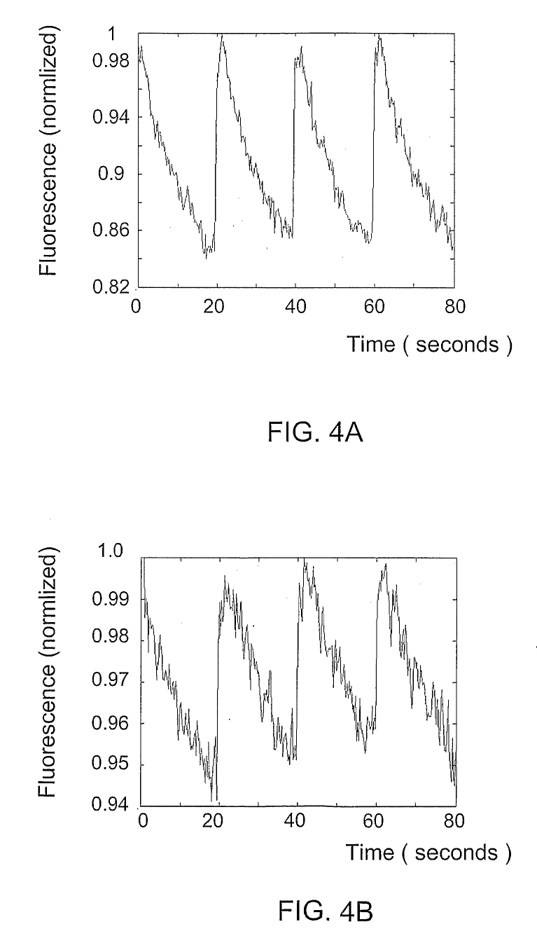

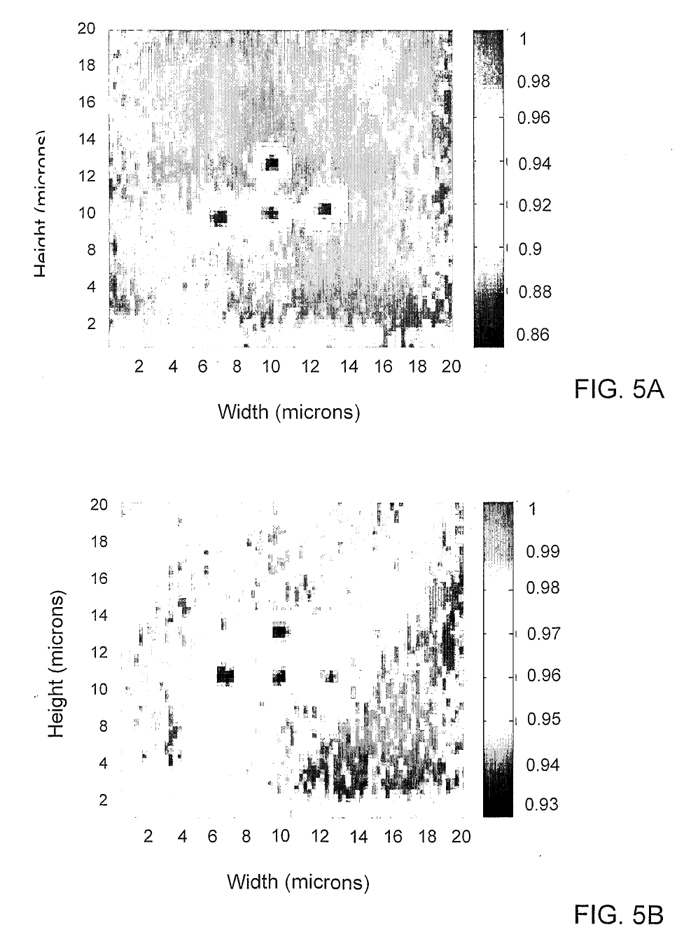

The sample was put on a copper holder that was heated using a power resistor. The holder was connected to a PI Nanocube in order to provide compensation for holder expansion during heating. A calibration cycle was done, in which the offsets resulting from expansion were measured. 4 spots were written at 90° C. Each spot was written for 20 seconds. The same pattern was written at 30° C. The reading of the written data (at 30° C. and at 90° C.) as reflected by the fluorescence was monitored. As can be seen, the fluorescence at FIG. 4(A) is much more pronounced (0.98-0.84) than the fluorescence in FIG. 4(B) (0.98-0.94). The spots were scanned using the PI nanocube. The following FIGS. 5(A) and 5(B) show the results of the scans of the information written at the temperatures 90° C. and 30° C., respectively. Undoubtedly, FIG. 5(A) demonstrates a more clear reading reflecting a more precise writing than the writing at 30° C.

1-20. (canceled)

21. A method for data inscription in a polymer-based photochromic medium in which the photochromic groups are bound to the polymeric matrix, the data being inscribed by irradiating small volume portion with an electromagnetic irradiation that causes a change in state of the photochromic groups from a first to a second state, the method comprises heating at least said volume portion to cause an increase in temperature of said portion at the time of data inscription.

22. A method according to claim 21, wherein the heating is achieved by a heating device that heats at least a portion of the medium prior to data inscription.

23. A method according to claim 21, wherein the heating is achieved through the use of additives in the medium that absorb electromagnetic irradiation and dissipate heat.

24. A method according to claim 23, wherein the additives dissipate heat in a non-irradiative manner.

25. A polymeric data storage medium, comprising a chromophore and at least one heating additive.

26. A polymeric data storage medium according to claim 25, herein said chromophore is bound as pendant groups to the polymeric backbone.

27. A polymeric data storage medium according to claim 25, herein the polymer is an acrylic polymer.

28. A polymeric data storage medium according to claim 27, herein said acrylic polymer is formed from one or both of methacrylate or methacrylate-based monomers.

29. A polymeric data storage medium according to claim 25, being a copolymer comprised of a co-polymerizable chromophore bound to a non-chromophoric monomeric group.

30. A polymeric data storage medium according to claim 25, wherein the chromophoric are active chromophore monomer is a diarylethene

31. A polymeric data storage medium according to claim 25, wherein the chromophoric are active chromophore monomer is a stilbene derivative

32. A polymeric data storage medium according to claim 25, wherein the chromophoric are active chromophore monomer having the following formula:
Ar¹C(R¹)═C(R²)Ar²-M (II)
wherein Ar¹ and Ar² are phenyl groups optionally independently substituted with one or more groups selected from toe group consisting of —C₁₋₆alkyls, —OC₁₋₆alkyl, —SC₁₋₆alkyl and, —C₁₋₆OH, thiols and their salts, NR′R″, R′ and R″ being independently hydrogen or C₁₋₆alkyl; R¹ and R² are substituents selected from the group consisting of nitrites selected from the group consisting of —(CH₂)ₙCN, n being 0, 1 or 2, halides, RCOOH, R being C₁₋₆alkyl, their C₁₋₆ esters, or a nitro compound selected from the group consisting of —(CH₂)ₙNO₂, n being 0, 1 or 2 and M is a polymerizable monomeric moiety.

33. A polymeric data storage medium according to claim 32, wherein M is an acrylic monomer.

34. A polymeric data storage medium according to claim 33, wherein M is methylmethacrylate or methylacrylate.

35. A polymeric data storage medium according to claim 34, wherein said active chromophore monomer is of the formula: 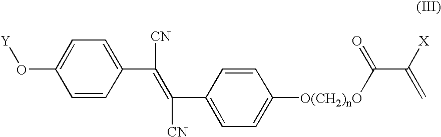
wherein X is methyl or hydrogen; n is an integer of 1 to 6; Y is hydrogen or a linear or branched alkyl moiety having 1 to 8 carbon atoms optionally substituted with halogens.

36. A polymeric data storage medium according to claim 35, wherein said active chromophore monomer is selected from the group consisting of the formulae (IV) and (V):

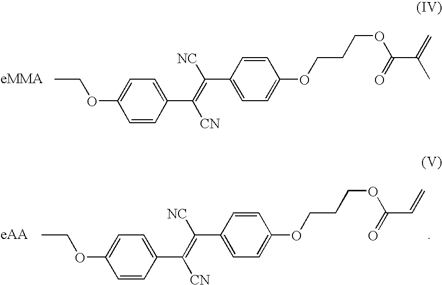

37. A polymeric data storage medium according to claim 25, wherein said heating additive is a non-fluorescent dye in a concentration of about 80 to 1400 ppm.

38. A three-dimensional optical memory comprising a polymeric data storage medium according to claim 25.

39. A three-dimensional optical memory unit comprising a memory according to claim 34, means for irradiating the chromophore and means for irradiating the heating additive.

40. A method for facilitating inscribing of data in a photochromic medium intended for data storage, comprising use of a three-dimensional optical memory according to claim 25, wherein said dye is irradiated concurrently with inscribing data on said memory.

41. A method according to claim 40, wherein the irradiation of the dye is selective irradiation at the vicinity of data inscription.

42. A method according to claim 41, wherein said dye is irradiated concurrently with inscribing data on said memory, the dye irradiation being non-selective for portion of said memory larger than the portion in which data is inscribed.

43. A method for facilitating inscribing of data in a photochromic medium intended for data storage, comprising use of a three-dimensional optical memory according to claim 25, wherein said optical memory or a portion thereof is heated during data inscription.
